(19) United States
(12) Patent Application Publication
(10) Pub. No.: US 2015/0252285 A1
(43) Pub. Date: Sep. 10, 2015

(54) METHODS FOR EXTRACTION OF LIPIDS FROM WET ALGAL BIOMASS

(71) Applicant: THE JOHNS HOPKINS UNIVERSITY, Baltimore,, MD (US)

(72) Inventors: Marc Donohue, Ellicott City, MD (US); Scott Williams, Baltimore, MD (US)

(21) Appl. No.: 14/430,922

(22) PCT Filed: Sep. 25, 2013
(86) PCT No.: PCT/US2013/061535

§ 371 Date: Mar. 25, 2015

Related U.S. Application Data
(60) Provisional application No. 61/705,472, filed on Sep. 25, 2012.

(51) Int. Cl. C11B 1/10

(52) U.S. Cl. CPC C11B 1/10

(57) ABSTRACT

The present invention provides novel methods for extraction of lipids from intact or lysed microorganisms in aqueous culture using a partially water soluble cosolvent with, or without a second organic solvent, and/or pressurized CO₂ in the extraction methods. Such a process can also be implemented at a much larger industrial scale, where the economics of scale based capital expenditures costs distributed over much higher volume production as well as increased equipment efficiency would significantly improve production rates and lower costs.

### REFERENCE TO RELATED APPLICATIONS

This application claims the benefit of U.S. Provisional Patent Application No. 61/705,472, filed on Sep. 25, 2012, which is hereby incorporated by reference for all purposes as if fully set forth herein.

### STATEMENT OF GOVERNMENTAL INTEREST

This invention was made with government support under grant no. DE-FG02-10ER85913 awarded by the Department of Energy. The government has certain rights in the invention.

### BACKGROUND OF THE INVENTION

Algal biomass containing high concentrations of lipids show potential as a source for sustainable biofuels. Separating the biomass into energy-dense lipids (and other valuable biosourced products including high-protein feed) remains an expensive obstacle to realizing algae biofuel processing in a cost-competitive manner. Current industrial solvent extraction processes, such as with hexane, are only compatible with dry feedstocks, requiring energy inputs to dewater algae in the growth condition which far exceed recovered fuel energy values. Distillation to recover the solvent from the extracted lipids is also highly energy intensive. Hexane as a solvent is also highly unfavorable due to environmental considerations, as well as human health and toxicity effects of hexane.

Current industrial solvent extraction processes, such as with hexane, are only compatible with dry feedstocks. The growth condition for algae biomass is >99.5% water content. A solvent such as hexane is not water soluble, which is favorable for separation from the aqueous phase. However, this immiscibility with water creates a substantial barrier to the interaction of the solvent (hexane) with the desired extractable lipids. Co-solvents can be used which exhibit solubility with both water and oil phases, such as ethanol or methanol. This solubility behavior overcomes the immiscibility barrier for extraction. However, the high water solubility of such solvents is significantly detrimental to the desired phase separation of oil and water.

As such, a need exists for improved methods of extraction of desired lipids from wet algal biomass.

### SUMMARY OF THE INVENTION

In accordance with an embodiment, the present invention provides a method for the isolation of lipids from microorganisms in an aqueous media comprising: a) adding to the aqueous media containing the microorganisms a sufficient amount of a first solvent solution comprising at least one or more solvents having partial water solubility to create a first mixture; b) mixing the mixture of a) for a sufficient period of time; c) adding to the mixture of a) a sufficient amount of a second solvent solution comprising at least one or more hydrophobic solvents to create a second mixture comprising at least an aqueous phase and an organic phase; d) mixing the mixture of c) for a sufficient period of time; and e) removing the organic phase containing the lipids from the microorganisms.

In accordance with another embodiment, the present invention provides a method for the isolation of lipids from microorganisms in an aqueous media comprising: a) adding to the aqueous media containing the microorganisms a sufficient amount of a first solvent solution comprising at least one or more solvents having partial water solubility, and a sufficient amount of a second solvent solution comprising at least one or more hydrophobic solvents to create a mixture comprising at least an aqueous phase and an organic phase; b) mixing the mixture of a) for a sufficient period of time; c) removing the organic phase containing the lipids from the microorganisms.

In accordance with another embodiment, the present invention provides a method for the isolation of lipids from microorganisms in an aqueous media comprising: a) adding to the aqueous media containing the microorganisms a sufficient amount of a solvent solution comprising at least one or more solvents having partial water solubility to create a mixture comprising at least an aqueous phase and an organic phase; b) mixing the mixture of a) for a sufficient period of time; c) removing the organic phase containing the lipids from the microorganisms.

### BRIEF DESCRIPTION OF THE DRAWINGS

FIG. 1 depicts a five-stage extraction comparison. Five sequential extractions were performed using each of the selected solvents at a 10:1 solvent to algae dry weight ratio. The total extraction efficiency for each system is the sum of the 5 steps shown in comparison to the total lipid content of the dry weight biomass as determined by Automated Solvent Extraction (ASE). 1-butanol totaled 80%±5%, heptane totaled 16%±6%, and hexane totaled 14%±4%. A significant reduction in recovery was observed after the second extraction.

FIG. 2 depicts a solvent extraction efficiency comparison. The extraction efficiency is determined by the comparison of recovered lipids to the total lipid content of the dry weight biomass as determined by the ASE. Samples are grouped by solvent compound (1-butanol, heptane, hexane) each at a distinct solvent to dry weight ratio. Grayscale bars show primary and secondary extraction. 2A. Extractions performed on dry algae; 2B. Algae sample 20% dry weight; 2C. Algae sample 2.5% dry weight, due to experimental limitations 2:1 solvent to dry weight ratio extractions were not conducted.

FIG. 3 depicts typical liquid-liquid phase separation behavior, after separation through centrifugation. The upper most layer is the organic layer, containing the solvent and lipids. The middle (clear) layer is water, which may contain dissolved water soluble cellular components. The lower dark layer is water-insoluble biomass. The two separate liquid phases (organic and aqueous) can be separated manually with a pipet for laboratory experiments, or with inline continuous hydrocyclones for large-scale applications.

FIG. 4 depicts lipid extraction data for a series of biomass samples with increasing water content, as extracted with heptane solvent. In the dry condition, the solvent is capable of extracting a significant amount of lipids. As the water content of the biomass is increased, the immiscible character of the solvent becomes a substantial barrier to lipid extraction. For reference, algae paste from a typical industrial continuous centrifuge is typically ˜80% water content.

### DETAILED DESCRIPTION OF THE INVENTION

In accordance with one or more embodiments, the present invention provides methods for extracting lipids and other valuable components form an aqueous mixture of biomass in water. A principle novel idea described herein is the use of a solvent (or co-solvent) with the properties of moderate water solubility. By using the solvent at a level higher than the solubility of the water, phase separation can be accomplished, with lipids in the solvent phase. In other embodiments, the co-solvent can be used in cooperation with an oil or organic phase or solvent to enhance phase separation. This is made possible through the use of a solvent with solubility partition behavior that significantly favors dissolution with oil as opposed to water (such as a high octonol-water partition constant). To ensure that the partially water soluble co-solvent interacts with the algae lipids, followed by partitioning into the oil or organic phase, in an embodiment, the cosolvent is added to the water and algae mixture prior the addition of the oil or organic extractant phase.

In other embodiments, the inventive methods provide that through appropriate selection, a partially water soluble co-solvent can be added in combination with an oil or organic phase in combination or simultaneously. In some embodiments of the present invention, an appropriately selected co-solvent can modify the solubility behavior of algae lipids, thus accomplishing extraction from algae biomass into the solvent plus oil or organic phase in a single step.

In accordance with an embodiment, the present invention provides a method for the isolation of lipids from microorganisms in an aqueous media comprising: a) adding to the aqueous media containing the microorganisms a sufficient amount of a first solvent solution comprising at least one or more solvents having partial water solubility to create a first mixture; b) mixing the mixture of a) for a sufficient period of time; c) adding to the mixture of a) a sufficient amount of a second solvent solution comprising at least one or more hydrophobic solvents to create a second mixture comprising at least an aqueous phase and an organic phase; d) mixing the mixture of c) for a sufficient period of time; and e) removing the organic phase containing the lipids from the microorganisms.

In accordance with an embodiment, the microorganisms of the present invention are optionally lysed or ruptured. The lying and/or rupturing of the microorganisms can be done prior to extraction with the first solvent, or concurrent thereto.

The microorganisms may also be intact whole cells. The microorganisms may be selected from the group consisting of consisting of algae, fungi, yeast, bacteria, cyanobacteria, and plant cells. As disclosed herein, the algae may be any oil-secreting or oil-producing algae and may include Athrospira, Bacillariophyceae, Chlamydomonas, Chlorella, Chlorophyceae, Chrysophyceae, Crypthecodinium, Cyanophyceae, Cyclotella, Danaliella, Haematococcus, Nannochloropsis, Navicula, Nitzschia, Phaeodactylum, Scenedesmus, Schizocytrium, Synechoeoccus, Synechocystis, Tetraselmis, Thaustochytrids, Ulkenia, Xanthophyceae, and algae that is genetically engineered to enhance or alter lipid production.

It will be understood by those of skill in the art that the term “lipids” can be used interchangeably with “oils” and the lipids can include neutral lipids or polar lipids. The lipids isolated by the methods practiced in the present invention may be used for biofuel production as well as other uses. The lipids isolated from the microorganisms may be re-circulated back to the media containing the microorganisms to increase separation efficiency therein and to isolate additional oil from the microorganism. The re-circulated oil may be used to further purify lipids secreted or produced by the microorganisms. Other bioproducts may optionally be isolated or secreted from the microorganisms disclosed herein.

In accordance with an embodiment, the water separated from aqueous phase can be recycled, for example, as growth medium for photosynthetic microorganisms in the methods of the present invention.

In accordance with an embodiment, the whole cell microorganisms are immobilized, for example by a solid substrate.

As used herein, the terms “milking” and “non-destructive extraction” are used to describe a process wherein the organism is treated with a solvent to remove lipids without causing significant loss of viability of the culture. The terms “non-destructive extraction” or extraction “essentially without killing” the organism, refers to cycles of extraction and recycling/recirculating of live extracted organisms to the culture system for regrowth or additional lipid and biomass production, and to the concept that the organism will survive at least one extraction cycle, but may be destroyed upon subsequent extraction cycles.

As used herein, the term “culture system” refers broadly to any system useful for culturing an organism. These can be ponds, raceways, bioreactors, plastic bags, tubes, fermentors, shake flasks, air lift columns, and the like.

As used herein, the term “oil” refers to molecules that are suitable feedstocks for the production of biofuels. Such oil may or may not be completely free of coextractants from the organism. Oil described herein may include lipids, preferably neutral lipids. In other embodiments, “oil” as refers to any combination of fractionable lipid fractions of a biomass.

As used herein, the terms “lipid,” “lipid fraction,” or “lipid component” can include any hydrocarbon soluble in non-polar solvents and insoluble, or relatively insoluble, in water, as well as amphiphilic molecules such as polar phospholipds. The fractionable lipid fractions can include, but are not limited to, free fatty acids, waxes, sterols and sterol esters, triacylglycerols, diacylglycerides, monoacylglycerides, tocopherols, eicosanoids, glycoglycerolipids, glycosphingolipds, sphingolipids, and phospholipids. The lipid fractions can also comprise other liposoluble materials such as chlorophyll and other algal pigments, including, for example, antioxidants such as astaxanthins.

“Membrane-bound lipids,” as used herein, refers to any lipid attached to or associated with the membrane of a cell or the cell wall, or with the membrane of any organelle within the cell. While the present invention provides methods for fractionating membrane-bound lipids, it is not so limited. The present invention can be used to fractionate intracellular lipids (e.g., lipids retained with the cell wall or in vacuoles) or extracellular lipids (e.g. secreted lipids), or any combination of intracellular, extracellular, cell wall bound, and/or membrane-bound lipids.

As used herein, a “continuous” extraction process is one in which the mixing/extracting/recycling steps occur continuously with minimal operator input for an extended period but is contemplated to be run and stopped at intervals as needed for maintenance or to maximize extraction productivity.

A “solute,” as used herein, refers to a substance that is dissolved in another substance, usually the component of a solution that is present in a lesser amount in the solution.

A “solvent,” as used herein, is a substance or material, in some cases a liquid or fluid, which is capable of dissolving another substance.

As used herein, the term “CO₂ solute” refers to CO₂ added in sufficient amounts to be dissolved by a substance or a system, including but not limited to biomass, whole cell or lysed microorganisms in aqueous media, oil, and/or water. As described herein, although CO₂ may be added in any amount, the invention methods use CO₂ as a solute and therefore it is not present in amounts to act as a solvent, as would be readily understood by one having ordinary skill in the art and described above.

The term “pressurized,” as used herein, refers to any pressure above atmospheric pressure that the microorganisms described herein tolerate or withstand. This may or may not include pressures at or above the supercritical pressure of CO₂. For example, the pressure is maintained below the supercritical pressure of CO₂.

The process of “sonication” is the treatment of a sample with high energy sound or acoustical radiation that is referred to herein as “ultrasound” or “ultrasonics.” Sonication is used in the art for various purposes including disrupting aggregates of molecules in order to either separate them or permeabilize them.

Using novel chemical engineering strategies, exemplary embodiments of the present invention are directed at increasing the yield of energy rich lipids that may be harvested from algae. Although many of the exemplary embodiments described below may be useful individually, the exemplary compositions, systems, and methods of the current system may work complimentarily to optimize both cost and yield.

The systems and methods disclosed herein may utilize a vast array of oleaginous organisms including alga, yeasts and fungi. Many algal species may be used in the methods of the invention. Some alga species include, without limitation: Athrospira, Bacillariophyceae, Chlamydomonas, Chlorella, Chlorophyeeae, Chrysophyceae, Crypthecodinium, Cyanophyceae, Cyclotella, Dunaliella, Haematococcus, Nannochloropsis, Navicula, Nitzschia, Phaeodactylum, Scenedesmus, Schizocytrium, Synechococcus, Synechocystis, Tetraselmis, Thaustochytrids, Ulkenia, Xanthophyceae, and algae that is genetically engineered to enhance or alter lipid production.

Suitable yeasts include, but are not limited to, Rhodotorula, Saccharomyces, and Apiotrichum strains.

Acceptable fungi species include, but are not limited to, the Mortierella strain.

In some embodiment, the methods of the present invention can be used for milking oils from algal cultures without harming the algae. One of the major costs associated with biofuel production is harvesting the biofuel from large volumes of culture media. Harvesting, rupturing, drying and extracting oils from algae accounts for 40-60% of the cost of producing biodiesel and places additional demands on culture replenishment. There is a need for a nondestructive, low cost oil extraction technology.

Certain microalgae have a high potential for lipid production. When grown heterotrophically, approximately 15-55% of the cell is lipid. However, even though the lipid content is high, if the lipids cannot be harvested essentially without harming the microalgae, then 45-85% (the non-lipid biomass) of the microalgal biomass will need to be regenerated in order to produce additional useful lipids.

As used herein, the term “aqueous media,” means the microorganism biomass mixed with water. The aqueous media can have any level of hydration, from a solution suitable for growth of the microorganisms to nearly dewatered, wet biomass of microorganisms.

Accordingly, in another embodiment described herein, are methods for non-destructive oil extraction from an microorganism, which include: (a) adding pressurized CO₂ to the aqueous media containing the microorganisms, wherein CO₂ is a solute that is dissolved by the microorganisms thereby increasing the buoyancy of the microorganisms; (b) isolating the microorganisms; (c) subjecting the microorganisms to rapid decompression thereby rupturing the microorganisms to obtain a mixture comprising a biomass phase, an aqueous phase, and an organic phase; d) adding to the mixture of c) a sufficient amount of a first solvent solution comprising at least one or more solvents having partial water solubility to create a second mixture; e) mixing the mixture of d) for a sufficient period of time; f) adding to the mixture of d) a sufficient amount of a second solvent solution comprising at least one or more hydrophobic solvents to create a third mixture comprising at least a biomass phase, an aqueous phase and an organic phase; g) mixing the mixture off) for a sufficient period of time; and h) removing the oil from the oleaginous organism to obtain an aqueous-organism mixture; obtaining an extracted aqueous fraction containing a viable extracted organism and an oil fraction; and a recycling step, in which at least a portion of the viable extracted organism is recycled into a culturing system.

In an exemplary system in some ways analogous to a dairy operation, the system allows for the collection of usable oil from the oleaginous organism essentially without rupturing or harming the organism.

While expressly not limited to theory, sonication is believed to improve oil extraction by breaking up the culture droplets into smaller particles allowing greater solvent exposure to the algae. Ultrasonic irradiation of microorganisms without damaging effects has been shown to be dose dependent at low frequency. As frequency increases, longer irradiation is tolerated by microorganisms. We use an optimal range of frequencies (20 kHz to 1 MHz) and intensities over different ultrasonic exposure times to optimize the extraction of oils without compromising the viability of cells. However, it should be appreciated that various other frequencies, intensities, and exposure times may also yield acceptable extraction efficiencies. Exemplary embodiments of the present invention release oils essentially without killing cells. However, it should be appreciated that various other frequencies, intensities, and exposure times may also yield acceptable extraction efficiencies, including frequencies between 20 kHz and 1 MHz, 20-100 kHz, 20-60 kHz, 30-50 kHz, or at 40 kHz. It is known that cell size, cell shape, cell wall composition and physiological state all affect the interaction of ultrasound with cells.

It will be understood by those of skill in the art that the methods of sonication described herein can be used for both non-destructive as well as for destructive methods of extraction of lipids from the algal biomass.

Besides the usable lipids already described, plant species such as algae are also known to produce important hydrophobic aromatic compounds. Some aromatic compounds such as naphthalene and toluene are important constituents in fuel products. Advantageously, the extraction techniques described herein may be used to extract many of these aromatic compounds as well as other useful oils previously described. These chemicals would not be extractable using current extraction techniques that rely on centrifugation and drying methods. Other plant species that produce such fuel products are also included in the invention.

Although algal extraction is the focus of many of the exemplary embodiments, the growth and recycle extraction process may also be used with other important oleaginous organisms. For example, organisms such as yeast and fungi would also be amenable to this type of purification process.

The ability of CO₂ to act as a solute for lipids and how its presence changes the physical properties of lipids/oil, and its use in extraction of lipids from algal cultures is described in WO2012/024340 and incorporated by reference in its entirety.

“Polar” as used herein, refers to a compound that has portions of negative and/or positive charges forming negative and/or positive poles. While a polar compound does not carry a net electric charge, the electrons are unequally shared between the nuclei. Water is considered a polar compound in the present invention.

“Non-polar” as used herein, refers to a compound that has no separation of charge, and so no positive or negative poles are formed. An example of a non-polar compound is a triacylglycerol (TAG) neutral lipid in the present invention.

“Miscible” as used herein, refers to a compound that can fully mix and dissolve with a fluid. “Water-miscible” refers to a compound that is fully soluble with water.

“Hydrophilic” as used herein, refers to a compound that is charge-polarized and capable of hydrogen bonding, i.e. polar, allowing it to dissolve readily in water.

“Hydrophobic” as used herein, refers to a compound that is repelled from water and tends to be non-polar and prefer other neutral molecules or non-polar molecules.

The term “biomass,” is used to refer to any living or recently dead biological cellular material derived from plants or animals. In certain embodiments, biomass can be selected from the group consisting of fungi, bacteria, yeast, mold, and microalgae. In other embodiments, the biomass can be agricultural products, such as corn stalks, straw, seed hulls, sugarcane leavings, bagasse, nutshells, and manure from cattle, poultry, and hogs, wood materials, such as wood or bark, sawdust, timber slash, and mill scrap, municipal waste, such as waste paper and yard clippings, or crops, such as poplars, willows, switchgrass, alfalfa, prairie bluestem, corn, and soybean. In certain embodiments, the biomass used with the invention is derived from algae.

Microalgae can be harvested by any conventional means (including, but not limited to filtration, flocculation, air flotation and centrifugation) and the algal paste generated by concentrating the harvested microalgae to the desired weight of solids. In some instances, the desired weight % of solids can be achieved by adding a solvent, preferably a polar solvent, to a batch of microalgae having a higher than desired weight % of solids. For example, this practice can be useful when it is desired to reuse the recycled polar solvent from a prior fractionation.

As used herein, the terms “fractionate,” “fractionating,” “fractioned” or “fractionation,” when used in conjunction with the fractionation of oil from a biomass, mean the separation of lipids from the cells of the biomass, whether those lipids remain associated with the cells from which they were derived or not. Thus, the term “fractionating” or its related forms can mean removing the oil from the cells to form a mixture comprising isolated lipids and cellular material, or it can be used to mean physically isolating and separating the lipids from the cellular material.

In certain embodiments, the biomass can be wild type or genetically modified yeast. Non-limiting examples of yeast that can be used with the present invention include Cryptococcus curvatus, Cryptococcus terricolus, Lipomyces starkeyi, Lipomyces lipofer, Endomycopsis vernalis, Rhodotorula glutinis, Rhodotorula gracilis, Candida 107, Saccharomyces paradoxus, Saccharomyces mikatae, Saccharomyces bayanus, Saccharomyces cerevisiae, any Cryptococcus, C. neoformans, C. bogoriensis, Yarrowia lipolytica, Apiotrichum curvatum, T. bombicola, T. apicola, T. petrophilum, C. tropicalis, C. lipolytica, and Candida albicans.

In certain embodiments, the biomass can be a wild type or genetically modified fungus. Non-limiting examples of fungi that can be used with the present invention include Mortierella, Mortierrla vinacea, Mortierella alpine, Pythium debaryanum, Mucor circinelloides, Aspergillus ochraceus, Aspergillus terreus, Pennicillium iilacinum, Hensenulo, Chaetomium, Cladosporium, Malbranchea, Rhizopus, and Pythium.

In other embodiments, the biomass can be any bacteria that generate lipids, proteins, and carbohydrates, whether naturally or by genetic engineering. Non-limiting examples of bacteria that can be used with the present invention include, but are not limited to, Escherichia coli, Acinetobacter sp. any actinomycete, Mycobacterium tuberculosis, any streptomycete, Acinetobacter calcoaceticus, P. aeruginosa, Pseudomonas sp., R. erythropolis, N. erthopolis, Mycobacterium sp., B., U. zeae, U. maydis, B. lichenformis, S. marcescens, P. fluorescens, B. subtilis, B. brevis, B. polmyma, C. lepus, N. erthropolis, T. thiooxidans, D. polymorphis, P. aeruginosa and Rhodococcus opacus.

The term “cosolvent,” as used herein means a solvent which has at least partial water solubility but has a higher solubility in the organic phase. Such solvents would include those with wherein the at least one cosolvent has an octanol-water partition coefficient (K_{ow}) of between about 0.2 to about 3.0. Examples of such solvents, include, but are not limited to 1-butanol, pentanol, benzyl alcohol and other alcohols, methyl-isobutyl-ketone, 2-pentanone, 3-pentanone and other ketones, carbon dioxide, diethyl ether, propyl acetate, and isoamyl acetate.

The term “organic solvent,” as used herein means a solvent which has a lipid character, and is soluble in the organic phase. Examples of organic solvents used in the methods of the present invention include soybean oil, canola oil, vegetable oil, flaxseed oil, corn oil, as well as non-polar solvents which can be used with the invention include, but are not limited to, carbon tetrachloride, chloroform, cyclohexane, 1,2-dichloroethane, dichloromethane, diethyl ether, dimethyl formamide, ethyl acetate, butane isomers, heptane isomers, hexane isomers, octane isomers, nonane isomers, decane isomers, methyl-tert-butyl ether, pentane isomers, toluene, hexane, heptene, octane, nonene, decene, mineral spirits (up to C12) and 2,2,4-trimethylpentane.

In accordance with some embodiments, in the initial extraction step a), the at least one or more solvents having partial water solubility to create a first mixture in the methods of the present invention can be present in a ratio of cosolvent:aqueous media v/v containing the microorganisms in a range of about 2:1 to about 20:1. In some embodiments, the range of the ratio of cosolvent:aqueous media containing the microorganisms can be 3:1, 4:1, 5:1, 10:1, 15:1, 18:1, and 20:1.

### EXAMPLES

Materials and Methods for Determination of Optimal Cosolvent Ratios. Research grade organic solvents (1-butanol, 99% hexane, heptane, chloroform, and methanol) were purchased from Sigma Co. (USA). Ottawa sand (20-30 mesh) (Fischer Scientific) and diatomaceous earth (SiO₂ approx. 95%) (Sigma-Aldrich). The processes and methods of the present invention can be performed using of standard laboratory equipment and disposable supplies; centrifuge tubes, desktop centrifuge, transfer pipettes, evaporation dishes, and scaled up for industrial methods.

Microalgae cultivation and harvesting. An axenic stock of Chlorella sorokiniana UTEX 1230 was obtained from the Culture Collection of Algae at the University of Texas in Austin and maintained on sterile 1.5% agar plates supplemented with Bold's Basal Medium (BBM). Liquid cultivation of C. sorokiniana UTEX 1230 was first inoculated in 10 ml of sterile BBM in T-25 tissue culture flasks and scaled up sequentially in 1-, 3-, and 8-L glass Bellco bioreactors before ultimately reaching mass culture in a cluster of six 140-L aquarium tanks. All cultures were aerated with filtered ambient air and illuminated continuously with an equal distribution of cool-white and daylight fluorescent bulbs (eight 40 watt fluorescent tube lights per tank). Microalgal biomass was harvested using an Evodos model T-10 continuous spiral plate centrifuge (Raamsdonksveer, The Netherlands) to produce the final algae paste. A sample of the algae biomass was investigated with a combination of thin layer chromatography (TLC) and gas chromatography/mass spectometry (GC/MS), and was found to exhibit negligible triacylglycerol (TAG) content, although other neutral lipids (mono-diacylglycerol) may be present.

Cell Disruption. The microalgal paste was homogenized using an EmulsiFlex-C3 manufactured by Avestin, Inc. The water content of the homogenized algae was measured about 20%. All the algal pastes were frozen in darkness until extraction. Dried algae were lyophilized using a Lyph-Lock 45 freeze dry system (Labconco) and were further disrupted using a mortar and pestle on the final powder.

Determination of total lipid content. The lyophilized samples and an equivalent amount of diatomaceous earth (Sigma-Aldrich) were weighed and ground using a mortar and pestle. The ground mixture was added to the Thermo Scientific Dionex Accelerated Solvent Extractor (A.S.E., Model 150) 22-mL cell and filled to 95% volume with Ottawa sand (Fischer Scientific). The cell was then placed in the ASE 150 chamber and extracted using the protocol defined by Mulbry et al. (J.A.O.C.S, 86.9:909-915 (2009)) with a solvent mixture comprised of a 2:1 ratio of chloroform:methanol (CHCl₃:CH₃OH). ASE extraction of total lipids content was performed in triplicate. From the extracted phase volatile solvents were evaporated under a fume hood. The residual lipids obtained from each sample were weighed and calculated to be 20.5% of dry weight. This value was subsequently used as the standard for the following extraction efficiency calculations.

Solvent extraction. Solvent extraction was performed in conical test tubes, either 15 ml (for samples of dry algae and 20% solids) or 50 ml (for samples of 2.5% solids). Extractions were performed at solvent to algae-DW ratios of 2:1, 5:1, 10:1, and 15:1 v/v. Results were not obtained for the 2:1 (solvent:algae-DW) extraction condition using 2.5% solid algae slurry due to difficulties in recovering a solvent phase from samples at such a high water content. For dry algae samples, a substantial amount of the primary solvent wetted the dry powder and was not recovered in the first extraction step. After mixing solvent with the sample in the second extraction cycle, water was added as a higher density liquid phase used to displace solvent from the biomass and increase solvent recovery. The algae and organic solvents were added to the tube and shaken mechanically using a Fisher Vortex Genie 2 for 2 minutes. The extraction process consisted of the following steps, (i) combine algal biomass and solvent (at the specific solvent to algae DW ratio) in the test tube; (ii) fix the tube horizontally to the Vortex Genie 2 and mix at 5,000 rpm for 2 minutes; (iii) centrifuge the tube and collect the solvent phase in an evaporating dish using a disposable transfer pipette; (iv) add fresh solvent to the tube (at the same solvent to algae DW ratio); (v) repeat step ii, mixing; (vi) when using dry algae, add 2 g water; (vii) repeat step iii, centrifugation and separation; (viii) evaporate the volatile solvent phase to obtain residual lipids. As a preliminary measure, 5 sequential extractions were performed on 20%-DW algae for each solvent (10 to 1 solvent to biomass ratio). Two sequential extractions were performed to generate all other results in the study. The residual lipids were weighed for each extraction step. Extraction efficiency (EE) was calculated by the following equation:

$$EE = ⌊ {\sum }_{i = 1}^{N} \frac{{X}_{i}}{DW \cdot {c}_{o}} ⌋ \cdot 100 \% \qquad Eq . 1$$

where Xᵢ is the residual lipids extracted from each step, N is the number of extraction steps, DW is the dry weight of the algae sample used, and cₒ is the total lipid content of the sample (0.205). All extractions were performed in triplicate and reported extraction efficiency values are averages with standard deviation as error values.

The following sections discuss the best results of each solvent system for different ratios of water to algal biomass and solvent to algal biomass. Unlike in previous approaches, which performed extractions at near boiling for over one hour, extractions are performed at ambient conditions for 2 minutes. The extraction efficiency values reported are the total of the first and second extraction steps from each condition compared to the algae biomass total lipid content as determined by the ASE.

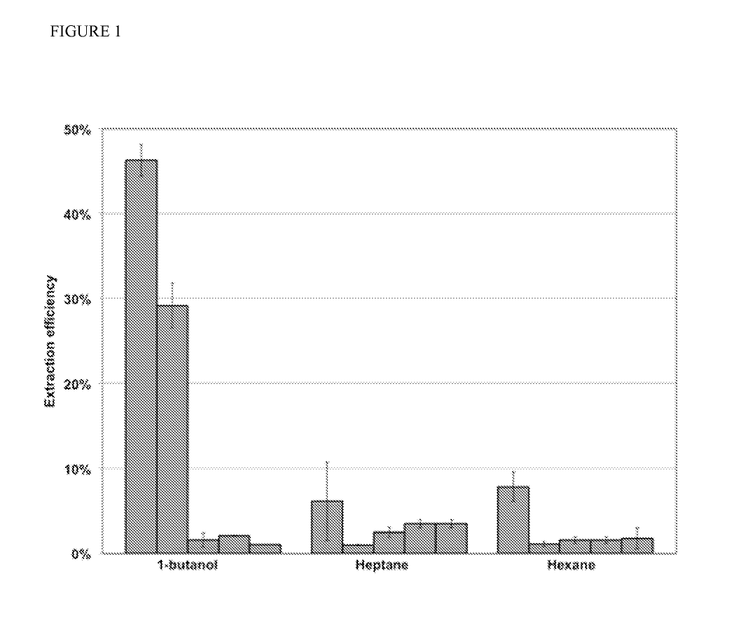

Results from a five-stage extraction of Chlorella sorokiniana UTEX 1230 (20%-DW, 20.5% lipids by DW), at a 10:1 solvent to DW ratio showed that after two extraction steps there is a significant reduction in additionally recovered residual lipids (Figure. 1). Based on these results, two extraction steps were deemed sufficient for subsequent trials.

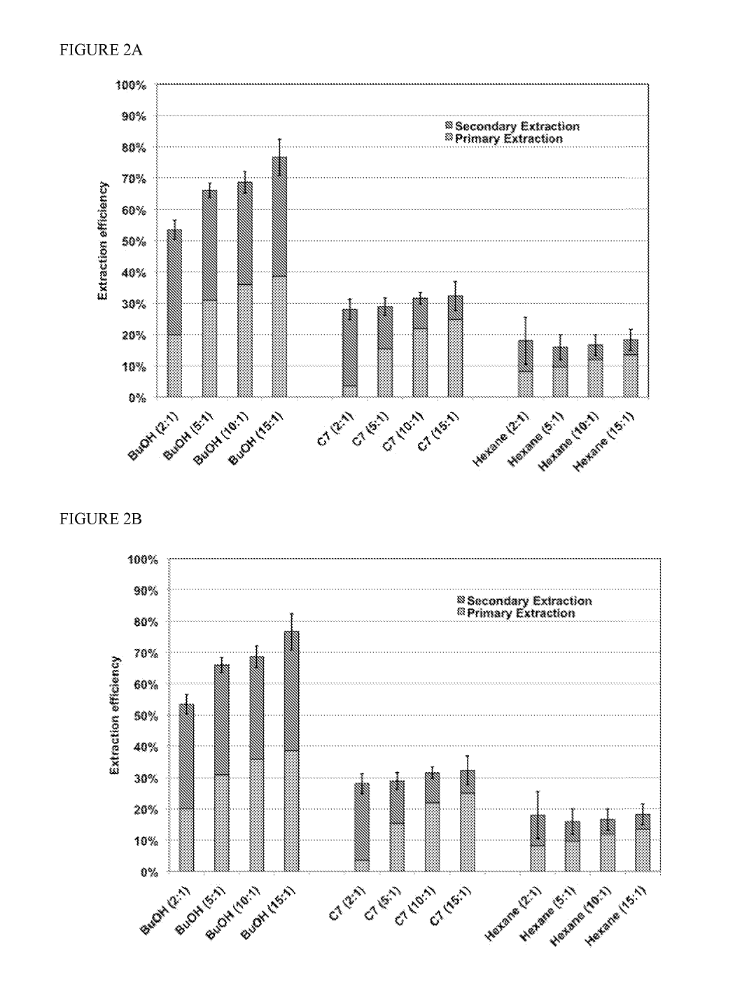

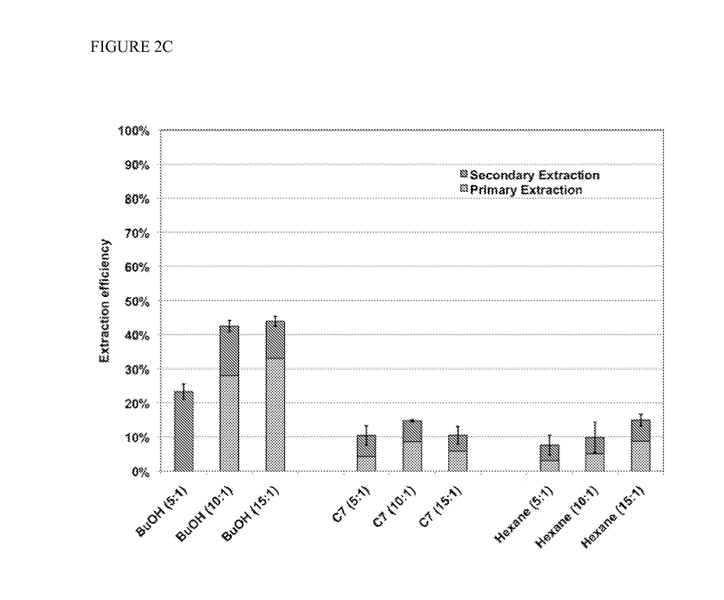

The highest extraction efficiency, relative to the ASE standard method, was obtained with 1-butanol, for all water to biomass ratios. The overall extraction efficiency using 1-butanol on dry algae increased as the ratio of solvent to biomass increased (FIG. 2A). The greatest average total extraction efficiency of 77%±6% of total lipids occurred at the highest solvent to biomass-DW ratio of 15:1. The extraction efficiency on 20%-DW algae decreased somewhat compared to that of dry algae (FIG. 2B). Higher solvent to biomass-DW ratio resulted in a higher overall extraction efficiency. Ratios of 15:1 and 10:1 (S:DW) exhibited similar extraction efficiencies of 66%±13% and 65%±7%, respectively. The extraction efficiency on 2.5%-DW algae also improved as the solvent to biomass-DW ratio increased (FIG. 2C). Ratios of 15:1 and 10:1 (S:W) exhibited similar extraction efficiencies of 44%±1% and 43%±2%, respectively.

The current results show that overall extraction efficiency is dependent on the solvent compound used. 1-butanol, a polar solvent with slight water solubility and an octanol-water partition coefficient (K_{ow}) of between about 0.2 to about 3.0, allows for greater interaction between the solvent and biomass to facilitate lipid extraction in both dry and aqueous environment. Butanol extraction may have been superior, at least in part, because of its ability to extract the numerous polar components in microalgae. In addition, slight solubility of butanol in water may explain its ability to function even in samples with water and solids.

FIG. 2A shows that comparing polar (1-butanol) and non-polar solvents (heptane and hexane) for a dry algae biomass sample of mixed lipid character, the polar solvent exhibits a higher degree of extraction. Comparing the same solvent system between FIGS. 2A and 2B highlights the barrier to extraction that is presented by water. The slightly soluble solvent (1-butanol) exhibits higher extraction than the insoluble solvents (heptane and hexane) especially in the presence of water perhaps because of the greater compatibility of polar butanol with the water. However, FIG. 2C demonstrates that the extraction efficiency when using even a slightly soluble solvent (1-butanol) will be inhibited by the very higher water to solvent ratio for a fixed degree of mixing.

Methods using the two solvent extraction process of the present invention.

The inventive methods of lipid extraction and separation using a partially water soluble solvent has been studied and proven at the laboratory bench top scale. Such a process can also be implemented at a much larger industrial scale, where the economics of scale based capital expenditures costs distributed over much higher volume production as well as increased equipment efficiency would significantly improve production rates and lower costs. The following contains example implementations at each of this process at these two distinct operating scales.

Laboratory Scale. Green algae are grown in a small scale production model to facilitate the testing of lipid extraction. In an embodiment, the specific strain of algae is Chlorella sorokiniana (UTEX 1230). Large glass fish tanks of 150 L capacity are used for growth, with four tanks grown in tandem to provide sufficient biomass. The growth cycle is approximate 10-12 days. The algae cultures are monitored for cell concentration, biomass lipid content, temperature, pH, nutrients, and waste concentration. Culture concentration accomplished using cell counting (Mcell/mL), biomass concentration (g/L), and/or optical density (OD). Changes in culture concentration are used to calculate growth rate.

Nutrients for algae growth are supplied in the initial aqueous media, such as a mixture of Bold's Basal Media (BBM) or similar. Levels of nutrients and waste are monitored, and nutrients are replenished as needed, approximately every four days. Artificial light is supplied with fluorescent light tubes in fixtures. Each fixture consisting of six 40 W T12 reflector-type tubes and one fixture is placed along each long side of the 150 L tanks. In a 12 day growth cycle, approximately 140 kWh of electricity is used for lighting. Agitation is accomplished with a bubbler tube placed inside the long bottom edge of each tank. Air is supplied using a low-pressure high-flow rate blower fan. Bubbling along one side creates an up-flow of water along one side of the tank, and a corresponding down-flow along the opposite side of the tank. In addition, the bubbling provides a fresh supply of carbon dioxide of the water and assists in the removal of expelled oxygen from algae photosynthesis. Bubbled air can be supplemented with additional carbon dioxide to increase algae growth.

Harvesting occurs when the growth rate indicates the culture has completed log phase growth and reaches a steady state growth condition, approximately 2 g/L wet algae biomass. Algae biomass is harvested with a simple bowl type centrifuge, such as a Raw Power brand centrifuge with the following operating parameters: harvesting flow rate of 80 L/hr, acceleration of 3600 G, bowl capacity of 600 cm³, electrical usage of 0.25 kWh/hr. To harvest four 150 L tanks takes 9 hours (1 hr of hands-on labor and 8 hours of centrifuge running), uses 2.25 kWh of electricity, and collects 1200 g of algae biomass. The collected biomass is in a wet paste form, consisting of 3% external free water. The algae cells still contain about 80% intercellular water. Therefore, 1200 g of paste is about 200 g of dry weight algae.

At a laboratory scale, a bowl centrifuge is used for simplicity and convenience. The wet algae paste is in fact too highly concentrated for wet solvent extraction. The paste is diluted to a concentration of about 250 g/L wet algae biomass. The water-algae mixture is run through a high pressure homogenizer, the EmulsiFlex C3 model produced by Avestin. The semi-continuous extrusion process creates pressure of 25000 PSI, which ruptures the algae cells completely.

The water-algae mixture is checked for wet biomass concentration through a simple test based on centrifugation. Four microcnetrifuge tubes, each 2 mL in size, are filled with the water-algae mixture, and spun in a centrifuge at 13,000 rpm for 5 minutes. As a result, the biomass forms a puck at the bottom of the tube. The mass of the tubes is determined with an analytical balance, the water is poured off, and the mass is measured again. The wet biomass concentration (g/L) is determined from the mass of wet biomass and the mass of initial water-algae mixture.

The water-algae mixture is also checked for dry weight biomass with a test based on evaporation. An evaporating container, such as a petri dish, for example, is filled half full with ethanol, approximately 5 mL. A quantity of water-algae mixture is added to the ethanol, approximately 5 mL. The mass of the dish is recorded empty, when filled with ethanol, and when filled with ethanol and water-algae. The dish is allowed to evaporate overnight in a fume hood. The mass of the dish is recorded after evaporation. The dry weight of algae biomass is determined and compared to the weight of water-algae mixture to calculate the dry biomass concentration (g/L).

Algae lipids are extracted from the water-algae mixture in a disposable 50 mL conical centrifuge tube. An analytical balance is used to determine the mass of water-algae and solvent, due to the higher precision of mass measurements as compared to volumetric measurements at this scale. The tube is filled with 20 g of water-algae mixture, to which 5 g of the at least one partially water soluble co-solvent, such as butanol, is added. The tube is closed and vigorous hand shaking is used to ensure mixing and interaction of the solvent with the water-algae mixture. A tabletop vortex generator can also be used to enhance mixing. The tube is reopened and 5 g of organic solvent, such as heptanes, is added to the tube, and then once again closed and vigorously mixed.

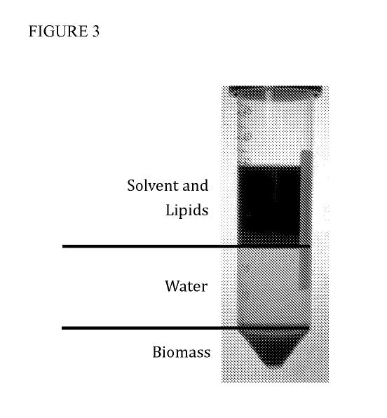

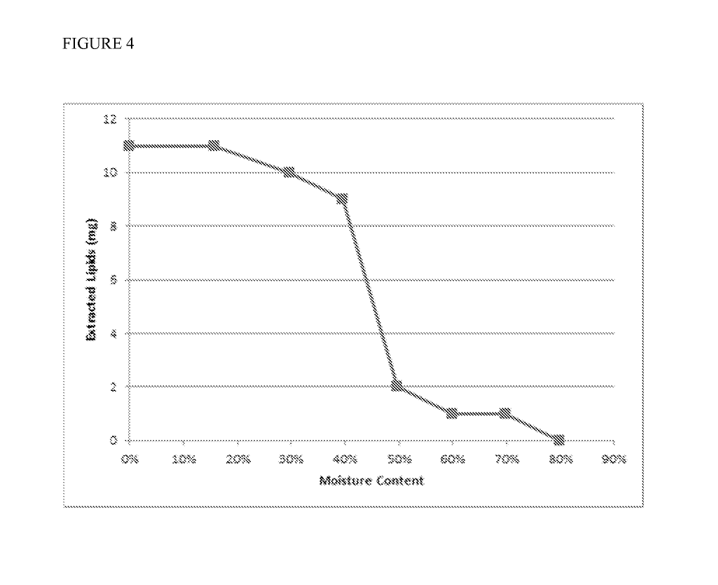

Forced separation of the aqueous phase and hydrophobic organic phase is accomplished with a desktop centrifuge. For separation, a rotor with swinging bucket arms is used so that the force of centrifugation is perpendicular to the vertical axis of the conical tube. Liquid layer separation is thus horizontal when removed from the centrifuge. One model of centrifuge with these capabilities is the Eppendorf 5804 R with the A-4-44 rotor and 50 mL rotor inserts. The sample tube is spun at 5000 rpm for 30 minutes (FIG. 3).

The centrifuge process results in four distinct layers within the 50 mL tube. In general, two liquid phases exist; the aqueous phase, with a density of about 1 g/cc is the lower phase, and the hydrophobic organic phase with a density of about 0.8 g/cc is the upper phase. At the bottom of the water phase is the reminder of the algae biomass, compacted into a dense pellet or puck. Between the two liquid layers is an emulsion layer. This consists of a mixture of tiny droplets of the water phase suspended in the organic phase. A small fraction of the algae biomass remains mixed within the water droplets in the emulsion. Testing data from experiments with and without water present with the biomass shows that the concentration of lipids in the organic phase remains constant whether the emulsion layer is present or not. The amount of lipids contained in the emulsion is proportional only to the fraction of organic phase which comprises the continuous phase of the emulsion, usually about 10% of the volume of the organic phase.

The organic phase is pipetted from the tube into an evaporating container, such as a petri dish. The volatile organic solvents, in this case butanol and heptane, are allowed to evaporate. The high surface area to volume ratio of the petri dish significantly improves the rate of evaporation. An analytical balance is used to determine the mass of the dish when empty, with the addition of the organic phase, and after the organic phase has been evaporated. The concentration of the lipids in the organic phase is then determined Using the measured dry weight concentration of the water-algae mixture, the amount of lipids separated from the biomass as a function of algae dry weight is calculated. This number is compared to other standard lipid extraction techniques such as Bligh and Dyer extraction, and/or Automated Solvent Extraction (ASE) to determine the efficiency of the wet solvent extraction process.

Vegetable oil can be used for a fraction of the hydrophobic organic extractant phase, such as being mixed in a 50/50 ratio with heptane. In that case, the partially water soluble butanol solvent functions to extract algae lipids from the aqueous biomass into the organic phase. The hydrophobic vegetable oil/heptane phase is immiscible with the water, and unable to efficiently extract lipids from the wet biomass. The partial water solubility of the butanol allows for a much higher degree of interaction with the biomass as compared to the oil/heptane phase. The high octonol-water partition constant of the butanol favors dissolution into the organic layer once it is added to the mixture, thus transferring algae lipids into the extractant phase. Heptane and butanol are then removed through evaporation or distillation. The remaining vegetable oil has a concentration of extracted algae lipids.

For modeling a scaled-up, large scale extraction process, the algae lipids must be separated from the vegetable oil extractant phase, which is then recycled for further extraction. The oil and lipid solution is added to a pressurized sight glass chamber, 50 mL added to a 100 mL chamber. Carbon dioxide is introduced into the sealed chamber from the bottom, thus bubbling up through the oil and lipid solution until 25 mL of CO₂ has been added. The pressure of the chamber is increased with the addition of CO₂ via means of a hydraulic pump, until the pressure is sufficiently high to induce phase separation between the neutral triacylglycerol (TAG) lipids of the vegetable oil and the more polar lipids extracted from the algae. With the dissolution of CO₂, the TAGs form the upper layer and the polar lipids form the lower layer. Maintaining pressure through the top of the pressure chamber, the lower phase is drained off into a secondary pressure vessel. The pressure is then lowered in both vessels, resulting in separated TAG lipids and algae lipids.

The lower aqueous phase from the centrifuge separation can be separated to recover the remaining algae biomass after lipid extraction. After pipetting away the organic phase, the emulsion layer can be removed using a small lab spatula. Then, the water phase is simply decanted into another container, with the algae biomass remaining in a consolidated puck at the bottom of the tube. The biomass is removed from the tube using a spatula, resulting in a high-protein algae biomass. The biomass is transferred into a Petri dish and allowed to air dry. Alternatively, the dish with the biomass is placed into a heated oven for more rapid drying.

Industrial Scale. Appropriate selection criteria are applied to find an algae strain capable of withstanding open pond growth. Growth rate and lipid production rate are then optimized to give high lipid yield, in accordance with methods known in the art. Raceways are covered to limit water loss due to evaporation, as well as contamination into and out of the ponds. Growth ponds are raceway designs, double-U-shaped pathways with flow created by paddlewheels. Natural light is sourced directly from the sun. Mixing results from the paddlewheels, and turbulence-inducing raceway features. Carbon dioxide can be bubbled into the ponds from nearby point sources such as fuel cell stacks. Nutrients are provided from anaerobic digester effluent, which also provides agricultural waste remediation as a source of income. Raceway conditions are monitored by arrays of commercially available sensors, including measurements of temperature, dissolved oxygen, pH, optical density, algae lipid content, and nutrient and waste levels. Blowdown cycles are used to counteract the problems of mineral concentration in a reticulating growth environment.

Algae biomass is harvested by directly drawing from the ponds in the stable growth condition. Biomass concentration is drastically increased with the use of natural flocculants, up to levels of 100 g/L wet biomass. Water is recycled back into the raceways. Algae concentration is further increased through the use of hydrodynamic separation, up to 250 g/L wet biomass, and the water phase is again recycled.

The harvested biomass slurry is pumped through static mixers, where partially water soluble co-solvents such as butanol are added to the mixture. The slurry is run through a series of in-line ultrasonic transducers. Cavitation ruptures and breaks down the cells, while the butanol co-solvent is further mixed with the biomass. Vegetable oil is introduced into the slurry as the organic extractant phase, and further inline mixing is induced. The pH of the mixture is monitored and controlled to mitigate the formation of an emulsion layer during separation. High flow pressure boosting pumps increase the flow of the slurry. Multi-stage inline continuous hydrocyclones are used to achieve separation between the hydrophobic organic phase and the aqueous phase, and to increase the concentration of proteinaceous algae biomass in the aqueous phase. Water is monitored for residual butanol content, and recycled to the growth ponds. The concentrated high-protein algae paste is dried and prepared for feed as appropriate, whether it be aquaculture feed, agricultural feed, or similar. Butanol is separated from the organic phase through distillation, after which recovered butanol is recycled for further extraction. The vegetable oil TAG lipids combined with the extracted algae lipids pumped into pressurized CO₂ processing pipes. The CO₂ induces phase separation between neutral TAG lipids and non-neutral lipids. Hydrocyclones are employed at pressure to achieve liquid-liquid phase separation. To keep capital costs down on pressurized equipment, the cyclones are implemented at a small scale in parallel to maintain high flow throughput. The vegetable oil TAG lipids are recycled for use in further extraction. The extracted algal lipids are ready for further processing, such as dehydrogenation or hydrothermal cracking to produce drop-in fuel replacements for use in aviation, transportation and power production applications.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for the isolation of lipids from microorganisms in an aqueous media comprising:
a) adding to the aqueous media containing the microorganisms a sufficient amount of a first solvent solution comprising at least one or more solvents having partial water solubility to create a first mixture;
b) mixing the mixture of a) for a sufficient period of time;
c) adding to the mixture of a) a sufficient amount of a second solvent solution comprising at least one or more hydrophobic solvents to create a second mixture comprising at least an aqueous phase and an organic phase;
d) mixing the mixture of c) for a sufficient period of time; and
e) removing the organic phase containing the lipids from the microorganisms.

2-3. (canceled)

4. The method of claim 1, wherein the at least one solvent or cosolvent is selected from the group consisting of butanol, pentanol, benzyl alcohol and other alcohols, methyl-isobutyl-ketone, 2-pentanone, 3-pentanone and other ketones, carbon dioxide, diethyl ether, dimethyl ether, propyl acetate, and isoamyl acetate.

5. The method of claim 4, wherein the at least one cosolvent has an octanol-water partition coefficient (K_{ow}) of between about 0.2 to about 3.0

6. The method of claim 1, wherein the organic phase comprises lipids, hydrocarbons and/or oils.

7. The method of claim 1, wherein the at least one organic solvent or hydrophobic phase is selected from the group consisting of vegetable oil, soybean oil, canola oil, flaxseed oil, corn oil, palm oil, and hexane, heptane, linear and branched alkanes, alkenes, and similar compounds.

8. The method of claim 1, wherein the microorganisms are optionally lysed, ruptured, or mechanically or otherwise similarly disrupted prior to extraction and separation.

9. The method of claim 1, wherein the microorganisms are optionally lysed, ruptured, or mechanically or otherwise similarly disrupted during extraction.

10. The method of claim 1, wherein the microorganisms are intact cells.

11. The method of claim 1, wherein the separation of the organic and aqueous phases comprises the use of a centrifuge, a cyclone, or other phase separating device for phase separation.

12. The method of claim 1, wherein the method is continuous.

13. The method of claim 1, comprising removing the water from the aqueous phase.

14. The method of claim 1, wherein the aqueous phase is recycled as growth medium for photosynthetic microorganisms.

15. The method of claim 1, wherein additional bioproducts are optionally isolated or secreted from the microorganisms.

16. The method of claim 1, wherein the microorganisms are selected from the group consisting of algae, fungi, yeast, bacteria, cyanobacteria, and plant cells.

17. The method of claim 1, wherein the algae is selected from the group consisting of Athrospira, Bacillariophyceae, Chlamydomonas, Chlorella, Chlorophyceae, Chrysophyceae, Crypthecodinium, Cyanophyceae, Cyclotella, Dunaliella, Haematococcus, Nannochloropsis, Navicula, Nitzschia, Phaeodactylum, Scenedesmus, Schizocytrium, Synecho coccus, Synechocystis, Tetraselmis, Thaustochytrids, Ulkenia, Xanthophyceae, and algae that are genetically engineered to enhance or alter lipid production.

18. The method of claim 1, wherein the first solvent solution to biomass-DW ratio v/v is in a range of between about 2:1 to about 20:1.

19. The method of claim 18, wherein the first solvent solution to biomass-DW ratio is about 15:1.
